(19) United States
(12) Patent Application Publication
(10) Pub. No.: US 2016/0349857 A1
(43) Pub. Date: Dec. 1, 2016

(54) CONTROL METHOD AND ELECTRONIC DEVICE

(71) Applicants: BEIJING LENOVO SOFTWARE LTD., Beijing (CN); LENOVO (BEIJING) LIMITED, Beijing (CN)

(72) Inventor: BEN XU, BEIJING (CN)

(21) Appl. No.: 14/849,136

(22) Filed: Sep. 9, 2015

(30) Foreign Application Priority Data
May 25, 2015 (CN) 201510271736.7

(51) Int. Cl. G06F 3/03; G06F 1/16

(52) U.S. Cl. CPC G06F 3/03; G06F 1/1652

(57) ABSTRACT

The present disclosure provides a control method and an electronic device. The method comprises: displaying a reference line by a flexible screen of an electronic device; obtaining a fold line generated on the electronic device by a sensor of the electronic device, when a flexible deformation of the electronic device occurs due to an external force; determining an operation instruction of the electronic device generated when the flexible deformation of the electronic device occurs due to the external force, based on the reference line and the fold line.

### CROSS-REFERENCE TO RELATED APPLICATION(S)

This application claims priority to the Chinese Patent Application No. 201510271736.7, filed on May 25, 2015, entitled “CONTROL METHOD AND ELECTRONIC DEVICE”, which is incorporated herein by reference in its entirety.

### TECHNICAL FIELD

The present disclosure relates to a terminal control technique in an information processing field, and in particular, to a control method and an electronic device.

### BACKGROUND

With the development of science and technology, a concept of a flexible screen device has been proposed in an electronic device field. That is, the electronic device is a flexible screen. Such a flexible screen may improve the user's touch feel, and is much lighter and thinner. Currently, however, there is no operation intelligently performed in association with a shape and gesture of the electronic device, and thus the user's usage experience cannot be improved.

### SUMMARY

An embodiment of the present disclosure provides a control method, comprising:

displaying a reference line by a flexible screen of an electronic device;

obtaining, by a sensor of the electronic device, a fold line generated on the electronic device when a flexible deformation of the electronic device occurs due to an external force;

determining an operation instruction of the electronic device generated when the flexible deformation of the electronic device occurs due to the external force, based on the reference line and the fold line.

Another embodiment of the present disclosure provides an electronic device, comprising:

a flexible screen, configured to display a reference line by a screen;

a sensor, configured to obtain a fold line generated on the electronic device when a flexible deformation of the electronic device occurs due to an external force;

a processor, configured to determine an operation instruction of the electronic device generated when the flexible deformation of the electronic device occurs due to the external force, based on the reference line and the fold line.

The control method and the electronic device provided by the present disclosure may display a reference line by a screen, sense by a sensor of the electronic device a fold line generated when a flexible deformation of the electronic device occurs due to an external force, and determine a corresponding operation instruction according to the reference line and the fold line. As such, the electronic device may intelligently operate according to its own deformation and the reference line, improving the user's usage experience.

### BRIEF DESCRIPTION OF THE DRAWINGS

FIG. 1 is an illustrative flowchart of a control method according to an embodiment of the present disclosure;

FIG. 2 is a schematic diagram of a first exemplary scenario of an embodiment of the present disclosure;

FIG. 3 is a schematic diagram of a second exemplary scenario of an embodiment of the present disclosure;

FIG. 4 is a schematic diagram of a third exemplary scenario of an embodiment of the present disclosure;

FIG. 5 is a schematic diagram of a fourth exemplary scenario of an embodiment of the present disclosure;

FIG. 6 is a schematic diagram of a fifth exemplary scenario of an embodiment of the present disclosure;

FIG. 7 is a schematic diagram of a sixth exemplary scenario of an embodiment of the present disclosure;

FIG. 8 is a schematic diagram of a seventh exemplary scenario of an embodiment of the present disclosure;

FIG. 9 is a schematic diagram of an eighth exemplary scenario of an embodiment of the present disclosure; and

FIG. 10 is a schematic diagram of a structure of an electronic device according to an embodiment of the present disclosure.

### DETAILED DESCRIPTION

The present disclosure is described in detail in conjunction with the drawings and particular embodiments. Embodiments of the present disclosure provide a control method and an electronic device, which can solve at least the above problems with the conventional technical solutions.

### First Embodiment

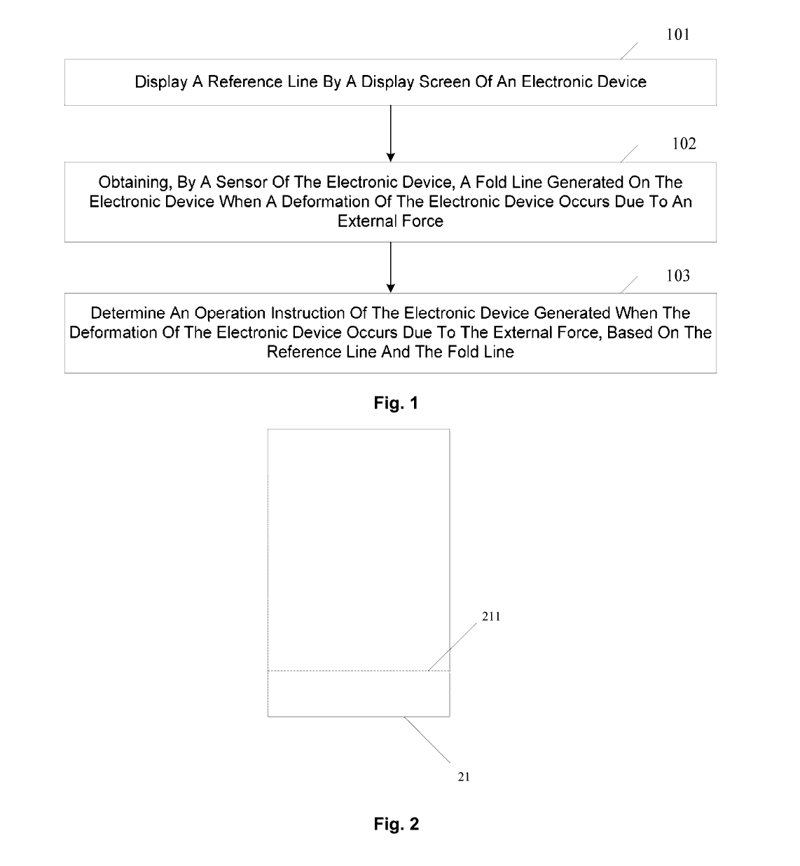

An embodiment of the present disclosure provides a control method. As shown in FIG. 1, the method comprises:

step 101 of displaying a reference line by a flexible screen of an electronic device;

step 102 of obtaining, by a sensor of the electronic device, a fold line generated on the electronic device when a flexible deformation of the electronic device occurs due to an external force;

step 103 of determining an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

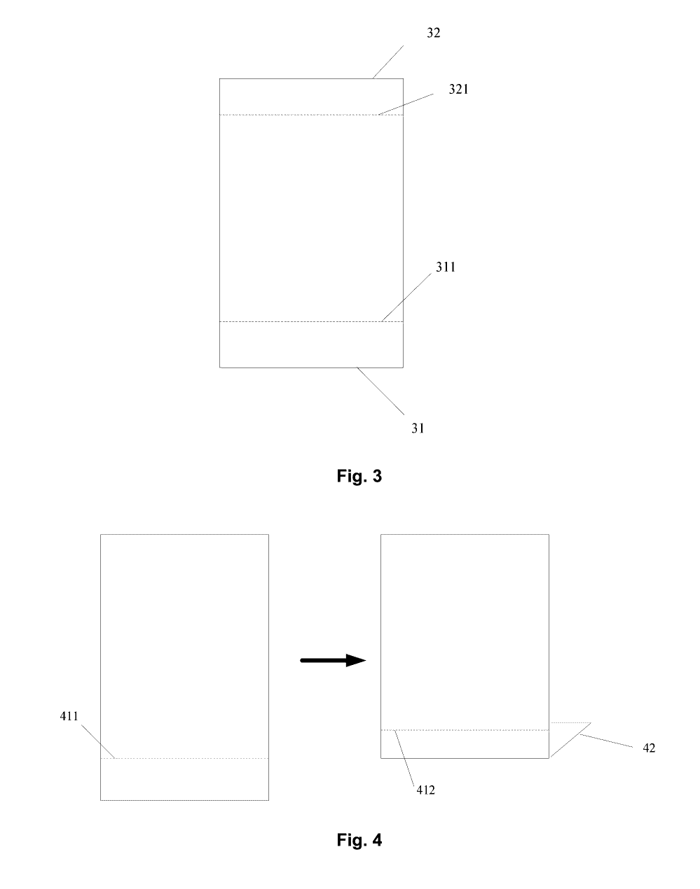

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

In addition, FIG. 2 and FIG. 3 only show scenarios with one reference line and two reference lines, respectively. It may be understood that, in practice, more reference lines may be displayed on the display screen of the electronic device. Alternatively, a plurality of reference lines may not be displayed simultaneously. For example, as shown in FIG. 4, when the electronic device is initially in a state as shown on the left of FIG. 4, a first reference line 411 is displayed for the user; when it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

The sensor of the electronic device may be a sensor disposed between the display screen of the electronic device and a bottom case of the electronic device. The sensor may be at least one pressure sensor.

Accordingly, obtaining the fold line generated on the electronic device when the flexible deformation of the electronic device occurs due to the external force may comprise:

obtaining, by the pressure sensors, pressures received by the display screen of the electronic device respectively;

when it is detected that a pressure variation value of at least one pressure sensor is larger than a first threshold which may be set according to actual situations, determining that the deformation occurs due to the external force received at a position corresponding to the at least one pressure sensor, and obtaining information on at least one position corresponding to the at least one pressure sensor;

generating the fold line based on the information on at least one position.

Alternatively, the sensor may be a flexible sensitive surface located on the upper surface or the lower surface of the flexible screen.

Accordingly, obtaining the fold line generated on the electronic device when the flexible deformation of the electronic device occurs due to the external force may comprise:

obtaining information on folded positions directly from the flexible sensitive surface, and

generating the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

It may be understood that a trigger condition of performing the step 101 in the present embodiment may be detection of user's operation information. When the operation information represents controlling the electronic device to display the reference line, the step 101 is performed. The operation information may firstly launch for the user a menu option which contains at least a menu item of “displaying a reference line”. When the user selects the menu item of “displaying a reference line” from the menu option, the step 101 is determined to be performed.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. Therefore, the electronic device may intelligently operate according to the reference line and the fold line, and the user's usage experience may be improved.

### Second Embodiment

An embodiment of the present disclosure provides a control method. As shown in FIG. 1, the method comprises:

step 101 of displaying a reference line by a flexible screen of an electronic device;

step 102 of obtaining, by a sensor of the electronic device, a fold line generated on the electronic device when a flexible deformation of the electronic device occurs due to an external force;

step 103 of determining an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

In addition, FIG. 2 and FIG. 3 only show scenarios with one reference line and two reference lines, respectively. It may be understood that, in practice, more reference lines may be displayed on the display screen of the electronic device. Alternatively, a plurality of reference lines may not be displayed simultaneously.

The sensor of the electronic device may be a sensor disposed between the display screen of the electronic device and a bottom case of the electronic device. The sensor may be at least one pressure sensor.

Accordingly, obtaining the fold line generated on the electronic device when the flexible deformation of the electronic device occurs due to the external force may comprise:

obtaining, by the pressure sensors, pressures received by the display screen of the electronic device respectively;

when it is detected that a pressure variation value of at least one pressure sensor is larger than a first threshold which may be set according to actual situations, determining that the deformation occurs due to the external force received at a position corresponding to the at least one pressure sensor, and obtaining information on at least one position corresponding to the at least one pressure sensor;

generating the fold line based on the information on at least one position.

Alternatively, the sensor may be a flexible sensitive surface located on the upper surface or the lower surface of the flexible screen.

Accordingly, obtaining the fold line generated on the electronic device when the flexible deformation of the electronic device occurs due to the external force may comprise:

obtaining information on folded positions directly from the flexible sensitive surface, and

generating the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

The step 103 of determining the operation instruction of the electronic device generated when the flexible deformation of the electronic device occurs due to the external force based on the reference line and the fold line may comprise: generating a switching instruction for switching operation modes of the electronic device, if the reference line matches with the fold line.

The step of displaying the reference line by the display screen of the electronic device may comprise: displaying at least one reference line corresponding to at least one operation mode by the display screen of the electronic device, wherein different operation modes correspond to different reference lines, the reference lines ensuring that the electronic device can be folded to respective gestures.

There may be a plurality of operation modes of the electronic device, e.g., a reading mode, a stand mode, a touch-control mode, a handheld mode etc.

When the electronic device is in the reading mode, the electronic device is in an expanding state, i.e., a state in which the flexible screen of the electronic device is not bent, so that the user may view content displayed by the electronic device.

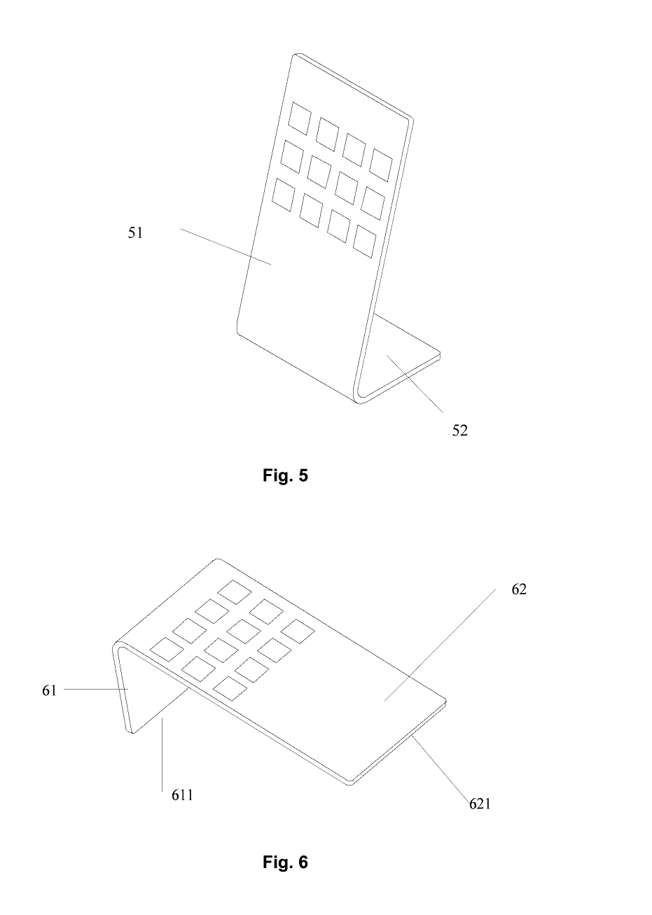

The stand mode may be shown as FIG. 5. The electronic device is bent along the reference line of the first side, so that the fold line and the reference line are matched with each other. The electronic device is divided into a support part 51 and a display part 52, in which screen content currently viewed by the user may be displayed in the display part 52, and the support part 51 may be set to be a black screen, the support part supporting on a bearing surface.

In the touch-control mode, the electronic device may be bent along the reference line of the second side, so that the fold line and the reference line are matched with each other. As shown in FIG. 6, the electronic device is divided into a second support part 61 and a second display part 62. At this time, the screen content currently viewed by the user may be stored in the second display part 62, and the second support part 61 may be set to be a black screen. Then, the electronic device is supported by a supporting element consisting of both the second side 611 of the second support part 61 and a third side 621 of the second display part 62. As such, the user may be provided with a more suitable angle of viewing the second display part, which is easier for the user to perform the touch-control operation.

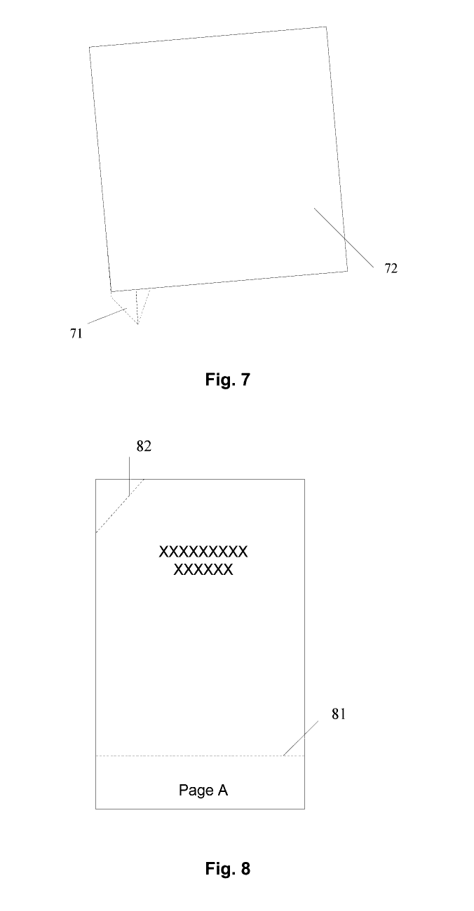

The handheld mode may be shown as FIG. 7, in which the electronic device comprises a handheld part 71 and a third display part 72. The handheld mode may be generated as shown in FIG. 4. Firstly, when the electronic device is in the state as shown on the left of FIG. 4, the first reference line 411 is displayed for the user; it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

Further, the operation modes in the present embodiment not only refer to usage states of the electronic device. For example, when the electronic device is in the reading mode, the display screen of the electronic device may be controlled to render lights suitable for the user's reading, and may display inquiry information inquiring whether the user wants to continue his reading with a file previously opened. Subsequent operations may be proceeded according to the processing result of the inquiry information by the user.

The electronic device in the touch-control mode may facilitate the user to operate on the touch-control screen of the electronic device. Therefore, the electronic device in the touch-control mode may focus on displaying applications requiring a plurality of interactive operations for the user, e.g., displaying the inquiry information which inquires whether the user wants to open some game having a higher click rate, and performing the subsequent operations according to the selection of the user.

The electronic device in the stand mode may facilitate the user to use the electronic device as a display screen. Therefore, the electronic device may be controlled to display only. At this time, the user may be prompt to select a video he wants to watch. As such, the operation mode may be determined by the electronic device to be switched according to the relationship between the fold line and the reference line for convenience of the use of the user.

It may be understood that a trigger condition of performing the step 101 in the present embodiment may be detection of user's operation information. When the operation information represents controlling the electronic device to display the reference line, the step 101 is performed. The operation information may firstly launch for the user a menu option which contains at least a menu item of “displaying a reference line”. When the user selects the menu item of “displaying a reference line” from the menu option, the step 101 is determined to be performed.

Hereinafter, a scenario provided for the present embodiment as described below will be illustrated.

Assuming that the electronic device is currently in the reading mode, the electronic device displays at least one reference line on the display screen according to the user's operation, in which each reference line corresponds to one operation mode. For example, the first reference line corresponds to the stand mode, and the second reference line corresponds to the touch-control mode.

The electronic device may be controlled to obtain, by the sensor, the fold line generated when the deformation occurs due to the external force.

It is determined whether the fold line matches with the first reference line or the second reference line. Assuming that the fold line matches with the first reference line in the scenario as shown, the electronic device is controlled to switch from the reading mode to the stand mode.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. As such, the electronic device may intelligently operate according to its own deformation and the reference line, improving the user's usage experience.

### Third Embodiment

An embodiment of the present disclosure provides a control method. As shown in FIG. 1, the method comprises:

step 101 of displaying a reference line by a flexible screen of an electronic device;

step 102 of obtaining, by a sensor of the electronic device, a fold line generated on the electronic device when a flexible deformation of the electronic device occurs due to an external force;

step 103 of determining an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

The sensor of the electronic device may be a sensor disposed between the display screen of the electronic device and a bottom case of the electronic device.

The sensor may be at least one pressure sensor.

Accordingly, obtaining the fold line generate on the electronic device when the flexible deformation of the electronic device occurs due to the external force may comprise:

obtaining, by the pressure sensors, pressures received by the display screen of the electronic device respectively;

when it is detected that a pressure variation value of at least one pressure sensor is larger than a first threshold which may be set according to actual situations, determining that the deformation occurs due to the external force received at a position corresponding to the at least one pressure sensor, and obtaining information on at least one position corresponding to the at least one pressure sensor;

generating the fold line based on the information on at least one position.

Alternatively, the sensor may be a flexible sensitive surface located on the upper surface or the lower surface of the flexible screen.

Accordingly, obtaining the fold line generated on the electronic device when the flexible deformation of the electronic device occurs due to the external force may comprise:

obtaining information on folded positions directly from the flexible sensitive surface, and

generating the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

The step 103 of determining the operation instruction of the electronic device generated when the flexible deformation of the electronic device occurs due to the external force based on the reference line and the fold line may comprise: generating a switching instruction for switching operation modes of the electronic device, if the reference line matches with the fold line.

The step of displaying the reference line by the display screen of the electronic device may comprise: displaying at least one reference line corresponding to at least one operation mode by the display screen of the electronic device, wherein different operation modes correspond to different reference lines, the reference lines ensuring that the electronic device can be folded to respective gestures.

There may be a plurality of operation modes of the electronic device, e.g., a reading mode, a stand mode, a touch-control mode, a handheld mode etc.

When the electronic device is in the reading mode, the electronic device is in an expanding state, i.e., a state in which the flexible screen of the electronic device is not bent, so that the user may view content displayed by the electronic device.

The stand mode may be shown as FIG. 5. The electronic device is bent along the reference line of the first side, so that the fold line and the reference line are matched with each other. The electronic device is divided into a support part 51 and a display part 52, in which screen content currently viewed by the user may be displayed in the display part 52, and the support part 51 may be set to be a black screen, the support part supporting on a bearing surface.

In the touch-control mode, the electronic device may be bent along the reference line of the second side, so that the fold line and the reference line are matched with each other. As shown in FIG. 6, the electronic device is divided into a second support part 61 and a second display part 62. At this time, the screen content currently viewed by the user may be stored in the second display part 62, and the second support part 61 may be set to be a black screen. Then, the electronic device is supported by a supporting element consisting of both the second side 611 of the second support part 61 and a third side 621 of the second display part 62. As such, the user may be provided with a more suitable angle of viewing the second display part, which is easier for the user to perform the touch-control operation.

The handheld mode may be shown as FIG. 7, in which the electronic device comprises a handheld part 71 and a third display part 72. The handheld mode may be generated as shown in FIG. 4. Firstly, when the electronic device is in the state as shown on the left of FIG. 4, the first reference line 411 is displayed for the user; it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

Further, the operation modes in the present embodiment not only refer to usage states of the electronic device. For example, when the electronic device is in the reading mode, the display screen of the electronic device may be controlled to render lights suitable for the user's reading, and may display inquiry information inquiring whether the user wants to continue his reading with a file previously opened. Subsequent operations may be proceeded according to the processing result of the inquiry information by the user.

The electronic device in the touch-control mode may facilitate the user to operate on the touch-control screen of the electronic device. Therefore, the electronic device in the touch-control mode may focus on displaying applications requiring a plurality of interactive operations for the user, e.g., displaying the inquiry information which inquires whether the user wants to open some game having a higher click rate, and performing the subsequent operations according to the selection of the user.

The electronic device in the stand mode may facilitate the user to use the electronic device as a display screen. Therefore, the electronic device may be controlled to display only. At this time, the user may be prompt to select a video he wants to watch.

As such, the operation mode may be determined by the electronic device to be switched according to the relationship between the fold line and the reference line for convenience of the use of the user.

Preferably, in the present embodiment, the step of determining the operation instruction of the electronic device generated when the flexible deformation of the electronic device occurs due to the external force based on the reference line and the fold line may further comprise: generating a control instruction in a current operation mode based on the flexible deformation of the electronic device due to the external force, if the reference line does not matches with the fold line.

The step of generating the control instruction based on the flexible deformation of the electronic device due to the external force may comprise: generating the corresponding control instruction according to the current operation mode of the electronic device.

For example, if the electronic device is currently in the reading mode, and the flexible deformation of the electronic device occurs close to any of four sides thereof, a page currently displayed by the electronic device is controlled to move or turn over toward the direction of the deformed side.

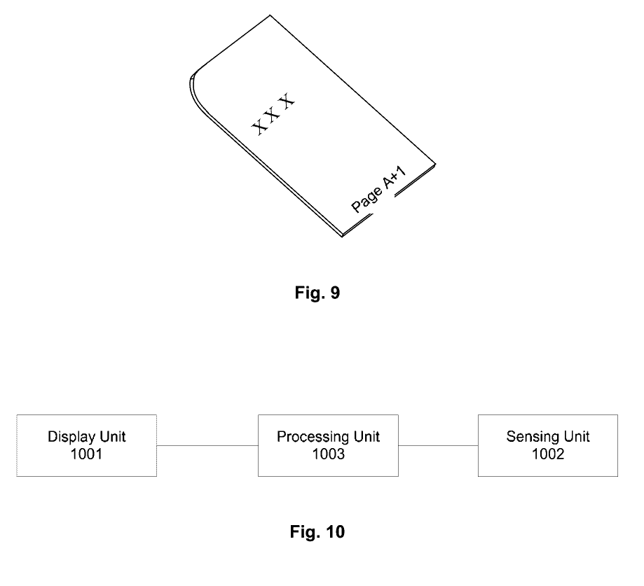

With reference to FIGS. 8 and 9, e.g., the electronic device in the reading mode as shown in FIG. 8 displays content of page A, a dotted line 81 displayed in the page may be a reference line for switching to the stand mode.

The fold line 81 generated by the electronic device when the deformation occurs due to the external force applied to the electronic device may be obtained by the sensor of the electronic device, as shown in FIG. 8, in which the fold line does not match with the reference line. Thus, the control instruction is generated in the current operation mode, based on the flexible deformation of the electronic device due to the external force.

After the deformation occurs due to the external force applied to the electronic device in FIG. 8, the shape of the electronic device changes as shown in FIG. 9. The deformation generated along the fold line 81 in the reading mode corresponds to a control instruction of turning to a next page. Thus, the content displayed in FIG. 9 is content of page A+1.

FIGS. 8 and 9 only show a situation in which the reference line and the fold line are not matched with each other in the reading mode. However, it may be understood that, in practice, there are corresponding operation instructions in other operation modes corresponding to the respective operation modes. For example, since the electronic device enters into a display state in the stand mode by default, the corresponding operation instruction may be playing a next video or may be pausing playing etc., assuming that the fold line is detected to be located opposing to the support part.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. As such, the electronic device may intelligently operate according to its own deformation and the reference line, improving the user's usage experience.

### Fourth Embodiment

An embodiment of the present disclosure provides a control method. As shown in FIG. 1, the method comprises:

step 101 of displaying a reference line by a flexible screen of an electronic device;

step 102 of obtaining, by a sensor of the electronic device, a fold line generated on the electronic device when a flexible deformation of the electronic device occurs due to an external force;

step 103 of determining an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The step of displaying the reference line by the display screen of the electronic device may comprise: generating and displaying the reference line by the display screen of the electronic device, when it is determined by the sensor of the electronic device that the deformation occurs due to the external force applied to the electronic device. The sensor of the electronic device may be a sensor disposed between the display screen of the electronic device and a bottom case of the electronic device. The sensor may be at least one pressure sensor.

The sensing the deformation due to the external force may comprise: sensing a pressure variation value generated by the at least one pressure sensor, and if the pressure variation value is larger than a predetermined threshold, determining that the electronic device receives the external force to generate the deformation.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

Accordingly, obtaining the fold line generated on the electronic device when the flexible deformation of the electronic device occurs due to the external force may comprise:

obtaining, by the pressure sensors, pressures received by the display screen of the electronic device respectively;

when it is detected that the pressure variation value of at least one pressure sensor is larger than a first threshold which may be set according to actual situations, determining that the deformation occurs due to the external force received at a position corresponding to the at least one pressure sensor, and obtaining information on at least one position corresponding to the at least one pressure sensor;

generating the fold line based on the information on at least one position.

Alternatively, the sensor may be a flexible sensitive surface located on the upper surface or the lower surface of the flexible screen.

Accordingly, obtaining the fold line generated on the electronic device when the flexible deformation of the electronic device occurs due to the external force may comprise:

obtaining information on folded positions directly from the flexible sensitive surface, and

generating the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

The step 103 of determining the operation instruction of the electronic device generated when the flexible deformation of the electronic device occurs due to the external force based on the reference line and the fold line may comprise: generating a switching instruction for switching operation modes of the electronic device, if the reference line matches with the fold line.

The step of displaying the reference line by the display screen of the electronic device may comprise: displaying at least one reference line corresponding to at least one operation mode by the display screen of the electronic device, wherein different operation modes correspond to different reference lines, the reference lines ensuring that the electronic device can be folded to respective gestures.

There may be a plurality of operation modes of the electronic device, e.g., a reading mode, a stand mode, a touch-control mode, a handheld mode etc.

When the electronic device is in the reading mode, the electronic device is in an expanding state, i.e., a state in which the flexible screen of the electronic device is not bent, so that the user may view content displayed by the electronic device.

The stand mode may be shown as FIG. 5. The electronic device is bent along the reference line of the first side, so that the fold line and the reference line are matched with each other. The electronic device is divided into a support part 51 and a display part 52, in which screen content currently viewed by the user may be displayed in the display part 52, and the support part 51 may be set to be a black screen, the support part supporting on a bearing surface.

In the touch-control mode, the electronic device may be bent along the reference line of the second side, so that the fold line and the reference line are matched with each other. As shown in FIG. 6, the electronic device is divided into a second support part 61 and a second display part 62. At this time, the screen content currently viewed by the user may be stored in the second display part 62, and the second support part 61 may be set to be a black screen. Then, the electronic device is supported by a supporting element consisting of both the second side 611 of the second support part 61 and a third side 621 of the second display part 62. As such, the user may be provided with a more suitable angle of viewing the second display part, which is easier for the user to perform the touch-control operation.

The handheld mode may be shown as FIG. 7, in which the electronic device comprises a handheld part 71 and a third display part 72. The handheld mode may be generated as shown in FIG. 4. Firstly, when the electronic device is in the state as shown on the left of FIG. 4, the first reference line 411 is displayed for the user; it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

Further, the operation modes in the present embodiment not only refer to usage states of the electronic device. For example, when the electronic device is in the reading mode, the display screen of the electronic device may be controlled to render lights suitable for the user's reading, and may display inquiry information inquiring whether the user wants to continue his reading with a file previously opened. Subsequent operations may be proceeded according to the processing result of the inquiry information by the user.

The electronic device in the touch-control mode may facilitate the user to operate on the touch-control screen of the electronic device. Therefore, the electronic device in the touch-control mode may focus on displaying applications requiring a plurality of interactive operations for the user, e.g., displaying the inquiry information which inquires whether the user wants to open some game having a higher click rate, and performing the subsequent operations according to the selection of the user.

The electronic device in the stand mode may facilitate the user to use the electronic device as a display screen. Therefore, the electronic device may be controlled to display only. At this time, the user may be prompt to select a video he wants to watch.

As such, the operation mode may be determined by the electronic device to be switched according to the relationship between the fold line and the reference line for convenience of the use of the user.

It may be understood that a trigger condition of performing the step 101 in the present embodiment may be detection of user's operation information. When the operation information represents controlling the electronic device to display the reference line, the step 101 is performed. The operation information may firstly launch for the user a menu option which contains at least a menu item of “displaying a reference line”. When the user selects the menu item of “displaying a reference line” from the menu option, the step 101 is determined to be performed.

Preferably in the present embodiment, the step of determining the operation instruction of the electronic device generated when the flexible deformation of the electronic device occurs due to the external force based on the reference line and the fold line may further comprise: generating a control instruction in a current operation mode based on the flexible deformation of the electronic device due to the external force, if the reference line does not matches with the fold line.

The step of generating the control instruction based on the flexible deformation of the electronic device due to the external force may comprise: generating the corresponding control instruction according to the current operation mode of the electronic device.

For example, if the electronic device is currently in the reading mode, and the flexible deformation of the electronic device occurs close to any of four sides thereof, a page currently displayed by the electronic device is controlled to move or turn over toward the direction of the deformed side.

With reference to FIGS. 8 and 9, e.g., the electronic device in the reading mode as shown in FIG. 8 displays content of page A, a dotted line 81 displayed in the page may be a reference line for switching to the stand mode.

The fold line 81 generated by the electronic device when the deformation occurs due to the external force applied to the electronic device may be obtained by the sensor of the electronic device, as shown in FIG. 8, in which the fold line does not match with the reference line. Thus, the control instruction is generated in the current operation mode, based on the flexible deformation of the electronic device due to the external force.

After the deformation occurs due to the external force applied to the electronic device in FIG. 8, the shape of the electronic device changes as shown in FIG. 9. The deformation generated along the fold line 81 in the reading mode corresponds to a control instruction of turning to a next page. Thus, the content displayed in FIG. 9 is content of page A+1.

FIGS. 8 and 9 only show a situation in which the reference line and the fold line are not matched with each other in the reading mode. However, it may be understood that, in practice, there are corresponding operation instructions in other operation modes corresponding to the respective operation modes. For example, since the electronic device enters into a display state in the stand mode by default, the corresponding operation instruction may be playing a next video or may be pausing playing etc., assuming that the fold line is detected to be located opposing to the support part.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. As such, the electronic device may intelligently operate according to its own deformation and the reference line, improving the user's usage experience.

### Fifth Embodiment

An embodiment of the present disclosure provides an electronic device. As shown in FIG. 10, the electronic device comprises:

a flexible screen 1001, configured to display a reference line by a screen;

a sensor 1002, configured to obtain a fold line generated on the electronic device when a flexible deformation of the electronic device occurs due to an external force;

a processor 1003, configured to determine an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

In addition, FIG. 2 and FIG. 3 only show scenarios with one reference line and two reference lines, respectively. It may be understood that, in practice, more reference lines may be displayed on the display screen of the electronic device. Alternatively, a plurality of reference lines may not be displayed simultaneously. For example, as shown in FIG. 4, when the electronic device is initially in a state as shown on the left of FIG. 4, a first reference line 411 is displayed for the user; when it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

The sensor of the electronic device may be a sensor disposed between the display screen of the electronic device and a bottom case of the electronic device. The sensor may be at least one pressure sensor. Accordingly, the processor is particularly configured to obtain pressures received by the display screen of the electronic device respectively by the pressure sensors; when it is detected that a pressure variation value of at least one pressure sensor is larger than a first threshold which may be set according to actual situations, determine that the deformation occurs due to the external force received at a position corresponding to the at least one pressure sensor, and obtain information on at least one position corresponding to the at least one pressure sensor; and generate the fold line based on the information on at least one position.

Alternatively, the sensor may be a flexible sensitive surface located on the upper surface or the lower surface of the flexible screen. Accordingly, the processor is configured to obtain information on folded positions directly from the flexible sensitive surface, and to generate the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

It may be understood that a trigger condition of performing the step of displaying the reference line by the display screen of the electronic device in the present embodiment may be detection of user's operation information. When the operation information represents controlling the electronic device to display the reference line, the step is performed. The operation information may firstly launch for the user a menu option which contains at least a menu item of “displaying a reference line”. When the user selects the menu item of “displaying a reference line” from the menu option, the step is determined to be performed.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. Therefore, the electronic device may intelligently operate according to the reference line and the fold line, and the user's usage experience may be improved.

### Sixth Embodiment

An embodiment of the present disclosure provides an electronic device. As shown in FIG. 10, the electronic device comprises:

a flexible screen 1001, configured to display a reference line by a screen;

a sensor 1002, configured to obtain a fold line generated on the electronic device when a flexible deformation of the electronic device occurs due to an external force;

a processor 1003, configured to determine an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

In addition, FIG. 2 and FIG. 3 only show scenarios with one reference line and two reference lines, respectively. It may be understood that, in practice, more reference lines may be displayed on the display screen of the electronic device. Alternatively, a plurality of reference lines may not be displayed simultaneously.

The sensor of the electronic device may be a sensor disposed between the display screen of the electronic device and a bottom case of the electronic device. The sensor may be at least one pressure sensor. Accordingly, the processor 1003 is particularly configured to obtain pressures received by the display screen of the electronic device respectively by the pressure sensors; when it is detected that a pressure variation value of at least one pressure sensor is larger than a first threshold which may be set according to actual situations, determine that the deformation occurs due to the external force received at a position corresponding to the at least one pressure sensor, and obtaining information on at least one position corresponding to the at least one pressure sensor; generate the fold line based on the information on at least one position.

Alternatively, the sensor may be a flexible sensitive surface located on the upper surface or the lower surface of the flexible screen. Accordingly, the processor is configured to obtain information on folded positions directly from the flexible sensitive surface, and to generate the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

The processor 1003 is particularly configured to generate a switching instruction for switching operation modes of the electronic device, if the reference line matches with the fold line.

The processor 1003 is particularly configured to display at least one reference line corresponding to at least one operation mode by the display screen of the electronic device, wherein different operation modes correspond to different reference lines, the reference lines ensuring that the electronic device can be folded to respective gestures.

There may be a plurality of operation modes of the electronic device, e.g., a reading mode, a stand mode, a touch-control mode, a handheld mode etc.

When the electronic device is in the reading mode, the electronic device is in an expanding state, i.e., a state in which the flexible screen of the electronic device is not bent, so that the user may view content displayed by the electronic device.

The stand mode may be shown as FIG. 5. The electronic device is bent along the reference line of the first side, so that the fold line and the reference line are matched with each other. The electronic device is divided into a support part 51 and a display part 52, in which screen content currently viewed by the user may be displayed in the display part 52, and the support part 51 may be set to be a black screen, the support part supporting on a bearing surface.

In the touch-control mode, the electronic device may be bent along the reference line of the second side, so that the fold line and the reference line are matched with each other. As shown in FIG. 6, the electronic device is divided into a second support part 61 and a second display part 62. At this time, the screen content currently viewed by the user may be stored in the second display part 62, and the second support part 61 may be set to be a black screen. Then, the electronic device is supported by a supporting element consisting of both the second side 611 of the second support part 61 and a third side 621 of the second display part 62. As such, the user may be provided with a more suitable angle of viewing the second display part, which is easier for the user to perform the touch-control operation.

The handheld mode may be shown as FIG. 7, in which the electronic device comprises a handheld part 71 and a third display part 72. The handheld mode may be generated as shown in FIG. 4. Firstly, when the electronic device is in the state as shown on the left of FIG. 4, the first reference line 411 is displayed for the user; it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

Further, the operation modes in the present embodiment not only refer to usage states of the electronic device. For example, when the electronic device is in the reading mode, the display screen of the electronic device may be controlled to render lights suitable for the user's reading, and may display inquiry information inquiring whether the user wants to continue his reading with a file previously opened. Subsequent operations may be proceeded according to the processing result of the inquiry information by the user.

The electronic device in the touch-control mode may facilitate the user to operate on the touch-control screen of the electronic device. Therefore, the electronic device in the touch-control mode may focus on displaying applications requiring a plurality of interactive operations for the user, e.g., displaying the inquiry information which inquires whether the user wants to open some game having a higher click rate, and performing the subsequent operations according to the selection of the user.

The electronic device in the stand mode may facilitate the user to use the electronic device as a display screen. Therefore, the electronic device may be controlled to display only. At this time, the user may be prompt to select a video he wants to watch. As such, the operation mode may be determined by the electronic device to be switched according to the relationship between the fold line and the reference line for convenience of the use of the user.

Hereinafter, a scenario provided for the present embodiment as described below will be illustrated.

Assuming that the electronic device is currently in the reading mode, the electronic device displays at least one reference line on the display screen according to the user's operation, in which each reference line corresponds to one operation mode. For example, the first reference line corresponds to the stand mode, and the second reference line corresponds to the touch-control mode.

The electronic device may be controlled to obtain, by the sensor, the fold line generated when the deformation occurs due to the external force.

It is determined whether the fold line matches with the first reference line or the second reference line. Assuming that the fold line matches with the first reference line in the scenario as shown, the electronic device is controlled to switch from the reading mode to the stand mode.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. As such, the electronic device may intelligently operate according to its own deformation and the reference line, improving the user's usage experience.

### Seventh Embodiment

An embodiment of the present disclosure provides an electronic device. As shown in FIG. 10, the electronic device comprises:

a flexible screen 1001, configured to display a reference line by a screen;

a sensor 1002, configured to obtain a fold line generated on the electronic device when a flexible deformation of the electronic device occurs due to an external force;

a processor 1003, configured to determine an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

The sensor of the electronic device may be a sensor disposed between the display screen of the electronic device and a bottom case of the electronic device. The sensor may be at least one pressure sensor. Accordingly, the processor 1003 is particularly configured to obtain pressures received by the display screen of the electronic device respectively by the pressure sensors; when it is detected that a pressure variation value of at least one pressure sensor is larger than a first threshold which may be set according to actual situations, determine that the deformation occurs due to the external force received at a position corresponding to the at least one pressure sensor and obtain information on at least one position corresponding to the at least one pressure sensor; generate the fold line based on the information on at least one position.

Alternatively, the sensor may be a flexible sensitive surface located on the upper surface or the lower surface of the flexible screen. Accordingly, the processor is configured to obtain information on folded positions directly from the flexible sensitive surface, and to generate the fold line based on the obtained information.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

The processor 1003 is particularly configured to generate a switching instruction for switching operation modes of the electronic device, if the reference line matches with the fold line.

The processor 1003 is particularly configured to display at least one reference line corresponding to at least one operation mode by the display screen of the electronic device, wherein different operation modes correspond to different reference lines, the reference lines ensuring that the electronic device can be folded to respective gestures.

There may be a plurality of operation modes of the electronic device, e.g., a reading mode, a stand mode, a touch-control mode, a handheld mode etc.

When the electronic device is in the reading mode, the electronic device is in an expanding state, i.e., a state in which the flexible screen of the electronic device is not bent, so that the user may view content displayed by the electronic device.

The stand mode may be shown as FIG. 5. The electronic device is bent along the reference line of the first side, so that the fold line and the reference line are matched with each other. The electronic device is divided into a support part 51 and a display part 52, in which screen content currently viewed by the user may be displayed in the display part 52, and the support part 51 may be set to be a black screen, the support part supporting on a bearing surface.

In the touch-control mode, the electronic device may be bent along the reference line of the second side, so that the fold line and the reference line are matched with each other. As shown in FIG. 6, the electronic device is divided into a second support part 61 and a second display part 62. At this time, the screen content currently viewed by the user may be stored in the second display part 62, and the second support part 61 may be set to be a black screen. Then, the electronic device is supported by a supporting element consisting of both the second side 611 of the second support part 61 and a third side 621 of the second display part 62. As such, the user may be provided with a more suitable angle of viewing the second display part, which is easier for the user to perform the touch-control operation.

The handheld mode may be shown as FIG. 7, in which the electronic device comprises a handheld part 71 and a third display part 72. The handheld mode may be generated as shown in FIG. 4. Firstly, when the electronic device is in the state as shown on the left of FIG. 4, the first reference line 411 is displayed for the user; it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

Further, the operation modes in the present embodiment not only refer to usage states of the electronic device. For example, when the electronic device is in the reading mode, the display screen of the electronic device may be controlled to render lights suitable for the user's reading, and may display inquiry information inquiring whether the user wants to continue his reading with a file previously opened. Subsequent operations may be proceeded according to the processing result of the inquiry information by the user.

The electronic device in the touch-control mode may facilitate the user to operate on the touch-control screen of the electronic device. Therefore, the electronic device in the touch-control mode may focus on displaying applications requiring a plurality of interactive operations for the user, e.g., displaying the inquiry information which inquires whether the user wants to open some game having a higher click rate, and performing the subsequent operations according to the selection of the user.

The electronic device in the stand mode may facilitate the user to use the electronic device as a display screen. Therefore, the electronic device may be controlled to display only. At this time, the user may be prompt to select a video he wants to watch.

As such, the operation mode may be determined by the electronic device to be switched according to the relationship between the fold line and the reference line for convenience of the use of the user.

Preferably in the present embodiment, the step of determining the operation instruction of the electronic device generated when the flexible deformation of the electronic device occurs due to the external force based on the reference line and the fold line may further comprise: generating a control instruction in a current operation mode based on the flexible deformation of the electronic device due to the external force, if the reference line does not matches with the fold line.

The step of generating the control instruction based on the flexible deformation of the electronic device due to the external force may comprise: generating the corresponding control instruction according to the current operation mode of the electronic device.

For example, if the electronic device is currently in the reading mode, and the flexible deformation of the electronic device occurs close to any of four sides thereof, a page currently displayed by the electronic device is controlled to move or turn over toward the direction of the deformed side.

With reference to FIGS. 8 and 9, e.g., the electronic device in the reading mode as shown in FIG. 8 displays content of page A, a dotted line 81 displayed in the page may be a reference line for switching to the stand mode.

The fold line 81 generated by the electronic device when the deformation occurs due to the external force applied to the electronic device may be obtained by the sensor of the electronic device, as shown in FIG. 8, in which the fold line does not match with the reference line. Thus, the control instruction is generated in the current operation mode, based on the flexible deformation of the electronic device due to the external force.

After the deformation occurs due to the external force applied to the electronic device in FIG. 8, the shape of the electronic device changes as shown in FIG. 9. The deformation generated along the fold line 81 in the reading mode corresponds to a control instruction of turning to a next page. Thus, the content displayed in FIG. 9 is content of page A+1.

FIGS. 8 and 9 only show a situation in which the reference line and the fold line are not matched with each other in the reading mode. However, it may be understood that, in practice, there are corresponding operation instructions in other operation modes corresponding to the respective operation modes. For example, since the electronic device enters into a display state in the stand mode by default, the corresponding operation instruction may be playing a next video or may be pausing playing etc., assuming that the fold line is detected to be located opposing to the support part.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. As such, the electronic device may intelligently operate according to its own deformation and the reference line, improving the user's usage experience.

### Eighth Embodiment

An embodiment of the present disclosure provides an electronic device. As shown in FIG. 10, the electronic device comprises:

a flexible screen 1001, configured to display a reference line by a screen;

a sensor 1002, configured to obtain a fold line generated on the electronic device when a flexible deformation of the electronic device occurs due to an external force;

a processor 1003, configured to determine an operation instruction of the electronic device generated when the flexible deformation of the electronic device occurs due to the external force, based on the reference line and the fold line.

Here, the electronic device may be an intelligent terminal with a flexible screen, e.g., a smart phone with a flexible screen, or a tablet with a flexible screen. The flexible screen may be for example a rollable display, a foldable display, or a bendable electronic paper and etc.

The processor 1003 is particularly configured to generate and display the reference line by the display screen of the electronic device, when it is determined by the sensor of the electronic device that the deformation occurs due to the external force applied to the electronic device.

The sensor of the electronic device may be a sensor disposed between the display screen of the electronic device and a bottom case of the electronic device. The sensor may be at least one pressure sensor. Accordingly, the sensing the deformation due to the external force may comprise: sensing a pressure variation value generated by the at least one pressure sensor, and if the pressure variation value is larger than a predetermined threshold, determining that the electronic device receives the external force to generate the deformation.

Alternatively, the sensor may be a flexible sensitive surface located on the upper surface or the lower surface of the flexible screen. As such, the deformation can be directly sensed by the flexible sensitive surface.

The reference line may be at least one line displayed on the display screen of the electronic device. For example, as shown in FIG. 2, a straight line 211 displayed close to a first side 21 is used as the reference line; or as show in FIG. 3, a first reference line 311 and a second reference line 321 are displayed respectively close to a first side 31 and a second side 32.

The fold line may be not shown by the flexible screen. That is, the fold line may be not visible to the user. Alternatively, in some implementations, the fold line may be displayed by the flexible screen, and thus is visible to the user.

The operation instruction in the present embodiment may be generated according to a fact whether the reference line and the fold line are identical.

The processor 1003 is particularly configured to generate a switching instruction for switching operation modes of the electronic device, if the reference line matches with the fold line.

The processor 1003 is particularly configured to display at least one reference line corresponding to at least one operation mode by the display screen of the electronic device, wherein different operation modes correspond to different reference lines, the reference lines ensuring that the electronic device can be folded to respective gestures.

There may be a plurality of operation modes of the electronic device, e.g., a reading mode, a stand mode, a touch-control mode, a handheld mode etc.

When the electronic device is in the reading mode, the electronic device is in an expanding state, i.e., a state in which the flexible screen of the electronic device is not bent, so that the user may view content displayed by the electronic device.

The stand mode may be shown as FIG. 5. The electronic device is bent along the reference line of the first side, so that the fold line and the reference line are matched with each other. The electronic device is divided into a support part 51 and a display part 52, in which screen content currently viewed by the user may be displayed in the display part 52, and the support part 51 may be set to be a black screen, the support part supporting on a bearing surface.

In the touch-control mode, the electronic device may be bent along the reference line of the second side, so that the fold line and the reference line are matched with each other. As shown in FIG. 6, the electronic device is divided into a second support part 61 and a second display part 62. At this time, the screen content currently viewed by the user may be stored in the second display part 62, and the second support part 61 may be set to be a black screen. Then, the electronic device is supported by a supporting element consisting of both the second side 611 of the second support part 61 and a third side 621 of the second display part 62. As such, the user may be provided with a more suitable angle of viewing the second display part, which is easier for the user to perform the touch-control operation.

The handheld mode may be shown as FIG. 7, in which the electronic device comprises a handheld part 71 and a third display part 72. The handheld mode may be generated as shown in FIG. 4. Firstly, when the electronic device is in the state as shown on the left of FIG. 4, the first reference line 411 is displayed for the user; it is determined that the electronic device deforms by being bent along the reference line 411 in a state as shown on the right of FIG. 4, in which a folded part 42 is a part generated by bending the electronic device along the first reference line 411 on the left part of FIG. 4, a second reference line 412 is displayed on the display screen as shown on the right of FIG. 4, prompting the user that the electronic device may be further bent along the second reference line to obtain a corresponding operation instruction.

Further, the operation modes in the present embodiment not only refer to usage states of the electronic device. For example, when the electronic device is in the reading mode, the display screen of the electronic device may be controlled to render lights suitable for the user's reading, and may display inquiry information inquiring whether the user wants to continue his reading with a file previously opened. Subsequent operations may be proceeded according to the processing result of the inquiry information by the user.

The electronic device in the touch-control mode may facilitate the user to operate on the touch-control screen of the electronic device. Therefore, the electronic device in the touch-control mode may focus on displaying applications requiring a plurality of interactive operations for the user, e.g., displaying the inquiry information which inquires whether the user wants to open some game having a higher click rate, and performing the subsequent operations according to the selection of the user.

The electronic device in the stand mode may facilitate the user to use the electronic device as a display screen. Therefore, the electronic device may be controlled to display only. At this time, the user may be prompt to select a video he wants to watch.

As such, the operation mode may be determined by the electronic device to be switched according to the relationship between the fold line and the reference line for convenience of the use of the user.

It may be understood that a trigger condition of performing the step 101 in the present embodiment may be detection of user's operation information. When the operation information represents controlling the electronic device to display the reference line, the step 101 is performed. The operation information may firstly launch for the user a menu option which contains at least a menu item of “displaying a reference line”. When the user selects the menu item of “displaying a reference line” from the menu option, the step 101 is determined to be performed.

Preferably in the present embodiment, determining the operation instruction of the electronic device generated when the flexible deformation of the electronic device occurs due to the external force based on the reference line and the fold line may further comprise: generating a control instruction in a current operation mode based on the flexible deformation of the electronic device due to the external force, if the reference line does not matches with the fold line.

Generating the control instruction based on the flexible deformation of the electronic device due to the external force may comprise: generating the corresponding control instruction according to the current operation mode of the electronic device.

For example, if the electronic device is currently in the reading mode, and the flexible deformation of the electronic device occurs close to any of four sides thereof, a page currently displayed by the electronic device is controlled to move or turn over toward the direction of the deformed side.

With reference to FIGS. 8 and 9, e.g., the electronic device in the reading mode as shown in FIG. 8 displays content of page A, a dotted line 81 displayed in the page may be a reference line for switching to the stand mode.

The fold line 81 generated by the electronic device when the deformation occurs due to the external force applied to the electronic device may be obtained by the sensor of the electronic device, as shown in FIG. 8, in which the fold line does not match with the reference line. Thus, the control instruction is generated in the current operation mode, based on the flexible deformation of the electronic device due to the external force.

After the deformation occurs due to the external force applied to the electronic device in FIG. 8, the shape of the electronic device changes as shown in FIG. 9. The deformation generated along the fold line 81 in the reading mode corresponds to a control instruction of turning to a next page. Thus, the content displayed in FIG. 9 is content of page A+1.

FIGS. 8 and 9 only show a situation in which the reference line and the fold line are not matched with each other in the reading mode. However, it may be understood that, in practice, there are corresponding operation instructions in other operation modes corresponding to the respective operation modes. For example, since the electronic device enters into a display state in the stand mode by default, the corresponding operation instruction may be playing a next video or may be pausing playing etc., assuming that the fold line is detected to be located opposing to the support part.

Thus, according to the above scheme, the reference line is displayed by the screen, the fold line generated when the flexible deformation of the electronic device occurs due to the external force is sensed by the sensor of the electronic device, and the corresponding operation instruction is determined according to the reference line and the fold line. As such, the electronic device may prompt the reference line, and may obtain, by the sensor, the fold line generated by its own deformation. As such, the electronic device may intelligently operate according to its own deformation and the reference line, improving the user's usage experience.

It can be appreciated from the embodiments of the present disclosure that the disclosed device and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

I/We claim:

1. A control method, comprising:
displaying a reference line by a flexible screen of an electronic device;
obtaining, by a sensor of the electronic device, a fold line generated on the electronic device when a flexible deformation of the electronic device occurs due to an external force;
determining an operation instruction of the electronic device generated when the flexible deformation of the electronic device occurs due to the external force, based on the reference line and the fold line.

2. The control method according to claim 1, wherein the determining the operation instruction of the electronic device generated when the flexible deformation of the electronic device occurs due to the external force based on the reference line and the fold line comprises:
generating a switching instruction for switching operation modes of the electronic device, if the reference line matches with the fold line.

3. The control method according to claim 2, wherein the displaying the reference line by the display screen of the electronic device comprises:
displaying at least one reference line corresponding to at least one operation mode by the display screen, wherein different operation modes correspond to different reference lines, the reference lines ensuring that the electronic device can be folded to respective gestures.

4. The control method according to claim 1, wherein the determining the operation instruction of the electronic device generated when the flexible deformation of the electronic device occurs due to the external force based on the reference line and the fold line comprises:
generating a control instruction in a current operation mode based on the flexible deformation of the electronic device due to the external force, if the reference line does not match with the fold line.

5. The control method according to claim 1, wherein the displaying the reference line by the display screen of the electronic device comprises:
generating and displaying the reference line by the display screen of the electronic device, when it is determined by the sensor of the electronic device that the flexible deformation of the electronic device occurs due to the external force.

6. An electronic device, comprising:
a flexible screen configured to display a reference line by a screen;
a sensor configured to obtain a fold line generated on the electronic device when a flexible deformation of the electronic device occurs due to an external force;
a processor configured to determine an operation instruction of the electronic device generated when the flexible deformation of the electronic device occurs due to the external force, based on the reference line and the fold line.

7. The electronic device according to claim 6, wherein the processor is further configured to generate a switching instruction for switching operation modes of the electronic device, if the reference line matches with the fold line.

8. The electronic device according to claim 7, wherein the processor is further configured to display at least one reference line corresponding to at least one operation mode by the flexible screen, wherein different operation modes correspond to different reference lines, the reference lines ensuring that the electronic device can be folded to respective gestures.

9. The electronic device according to claim 6, wherein the processor is further configured to generate a control instruction in a current operation mode based on the flexible deformation of the electronic device due to the external force, if the reference line does not match with the fold line.

10. The electronic device according to claim 6, wherein the processor is further configured to generate and display the reference line by the flexible screen of the electronic device, when it is determined by the sensor of the electronic device that the flexible deformation of the electronic device occurs due to the external force.
